(19) United States
(12) Patent Application Publication
(10) Pub. No.: US 2006/0246884 A1
(43) Pub. Date: Nov. 2, 2006

(54) Contact information sharing with mobile telephone

(75) Inventor: Mohammed I. Ansari, San Diego, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/117,875

(22) Filed: Apr. 29, 2005

(51) Int. Cl. H04B 7/00; H04M 3/00

(52) U.S. Cl. 455/419; 455/418; 455/41.2

(57) ABSTRACT

A system for a mobile telephone includes query of a first local external device for first contact information, and reception of the first contact information from the first local external device. According to some aspects, a system for a mobile telephone includes reception of a query from a first local external device for first contact information stored in the mobile telephone, and transmission of the first contact information to the first local external device.

### BACKGROUND

1. Field

Embodiments may relate to transmissions to and/or from mobile telephones. More particularly, some embodiments are concerned with the receiving contact information from a local external device and/or transmitting contact information to a local external device.

2. Description

Many types of personal electronic devices are currently available to consumers. A non-exhaustive list of such devices includes desktop computers, laptop computers, mobile telephones, personal digital assistants (PDAs), wireless email devices, and digital media players. Some of these devices are intended to provide several functions (e.g., desktop computers and laptop computers), while others are associated with a “core” function (e.g., mobile telephones, personal digital assistants (PDAs), wireless email devices, and digital media players). Regardless, most personal electronic devices are capable of providing two or more functions.

For example, many mobile telephones include features for capturing digital images as well as features for telephonic communication. Similarly, some PDAs provide Web browsing in addition to scheduling features. Digital media players may also provide Web browsing or digital recording.

Personal electronic devices often do not satisfactorily interoperate with one another with respect to their common functions. Such interoperation between two personal electronic devices may increase the utility of each of the two devices. The interoperation may also or alternatively reduce a need to master the operation of a common function on two different personal electronic devices. Improved interoperation of personal electronic devices is therefore desired.

### SUMMARY

According to some embodiments, a mobile telephone includes a communication device to transmit a query to a first local external device for first contact information, and to receive the first contact information from the first local external device. In some aspects, the telephone includes a processor to determine a plurality of local external devices that store respective ones of a plurality of contact information, and the telephone further includes an input device to receive an instruction to select the first local external device from the plurality of local external devices.

According to further aspects, the communication device is to transmit a query to the first local external device for a list representing all accessible contact information stored in the first local external device, and is to receive the list representing all accessible contact information from the first local external device. In these aspects, the mobile telephone may also include an output device to present the list to a user, and the input device may receive an instruction to select the first contact information from the list.

Embodiments may also provide a system, method, program code and/or means to query a first local external device for first contact information, and receive the first contact information from the first local external device. Aspects may further include determination of a plurality of local external devices that store respective ones of a plurality of contact information, and reception of an instruction to select the first local external device from the plurality of local external devices.

Some aspects may also or alternatively include query of the first local external device for a list representing all accessible contact information stored in the first local external device, reception of the list representing all accessible contact information from the first local external device, presentation of the list to a user, and reception of an instruction to select the first contact information from the list.

Embodiments may also provide a system, method, program code and/or means to receive a query from a first local external device for first contact information stored in the mobile telephone, and to transmit the first contact information to the first local external device. Aspects may also include a determination of whether the first local external device is authorized to receive the first contact information. Additional or alternative aspects may further include reception of a query from the first local external device for a list representing all accessible contact information stored in the mobile telephone, and transmission of the list representing all accessible contact information to the first local external device.

Some embodiments include a communication device to receive a query from a first local external device for first contact information stored in the mobile telephone, and to transmit the first contact information to the first local external device. Additional aspects may include a processor to determine if the first local external device is authorized to receive the first contact information. According to some aspects, the communication device is to receive a query from the first local external device for a list representing all accessible contact information stored in the mobile telephone, and to transmit the list representing all accessible contact information to the first local external device.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a diagram of a system according to some embodiments;

FIG. 2 is a flow diagram of a process according to some embodiments;

FIG. 3 is a flow diagram of a process according to some embodiments;

FIG. 4 is an outward view of a mobile telephone according to some embodiments;

FIG. 5 is a block diagram of the internal architecture of a system according to some embodiments;

FIG. 6 is a flow diagram of a process according to some embodiments;

FIG. 7 is a block diagram of a software architecture according to some embodiments;

FIG. 8 is an outward view of a mobile telephone according to some embodiments;

FIG. 9 is a tabular representation of a portion of a data structure according to some embodiments;

FIG. 10 is a representation of a system according to some embodiments;

FIG. 11 is an outward view of a mobile telephone according to some embodiments;

FIG. 12 is a tabular representation of a portion of a data structure according to some embodiments; and

FIG. 13 is an outward view of a telephone according to some embodiments.

### DETAILED DESCRIPTION

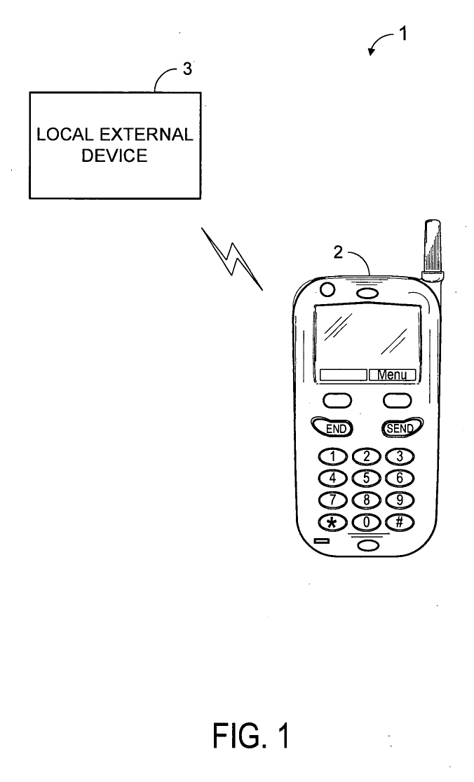

FIG. 1 is a diagram of system 1 according to some embodiments. System 1 of FIG. 1 includes mobile telephone 2 and local external device 3. According to some embodiments, mobile telephone 2 queries local external device 3 for contact information and receives the contact information from local external device 3. Mobile telephone 2 may receive a query from local external device 3 for contact information and may transmit the contact information to device 3 in some embodiments.

Local external device 3 may comprise any one or more devices. Examples include but are not limited to a mobile telephone, a desktop computer, a laptop computer, a handheld computer, a PDA, a digital media player, a digital camera, a wireless email device, and any other device or devices from which stored contact information may be transmitted and/or to which contact information may be transmitted. Such transmission(s) may be performed using any transmission system that is or becomes known.

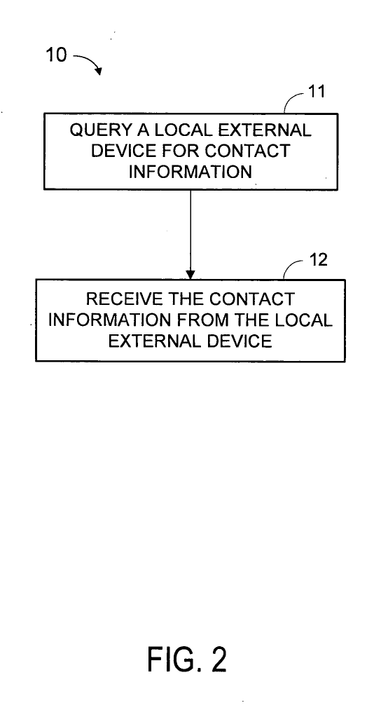

FIG. 2 is a flow diagram of process 10 according to some embodiments. Process 10 may be embodied in program code and/or executed by telephone 2 or another device using any suitable hardware and/or software arrangement.

Initially, at step 11, a local external device is queried for contact information. Such a query may be presented in any format suitable to the local external device. Similarly, the query may be transmitted via any transmission media and protocols compatible with the local external device.

As will be described in more detail below, the query may be transmitted in response to user input received by telephone 2. The user input may comprise a request for the contact information according to one example. Moreover, step 11 may be preceded by steps in which mobile telephone 2 discovers the local external device 2 and discovers that the local external device may provide contact information. Examples of the foregoing according to some embodiments will be described below.

Next, at step 12, the contact information is received from the local external device. The contact information may be received in any format and transmitted according to any suitable protocol over any suitable medium. In some embodiments, the contact information is transmitted via Radio Frequency (RF). The received contact information may be stored in mobile telephone 2 and/or used to contact a person according to some embodiments.

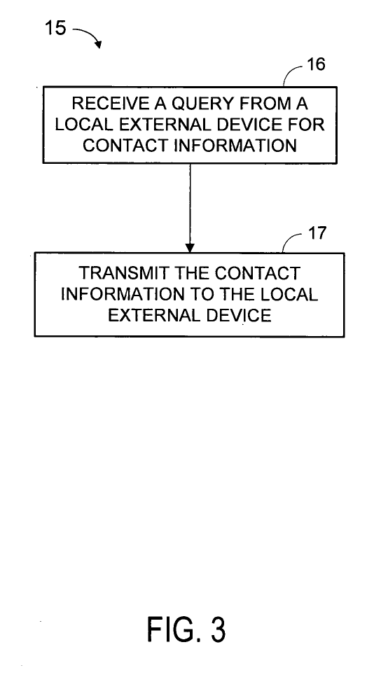

FIG. 3 is a flow diagram of process 15 according to some embodiments. Process 15 may be embodied in program code and/or executed by mobile telephone 2 or another device using any suitable hardware and/or software arrangement.

Mobile telephone 2 receives a query for contact information from a local external device at step 16. The query may be received according to any protocol and via any medium compatible with mobile telephone 2. Then, at step 17, mobile telephone 2 transmits the contact information to the local external device.

According to some embodiments, mobile telephone 2 determines whether the contact information is stored therein prior to step 17. Mobile telephone 2 may also determine prior to step 17 whether the local external device is authorized to receive the contact information. Some embodiments of the foregoing will be described below.

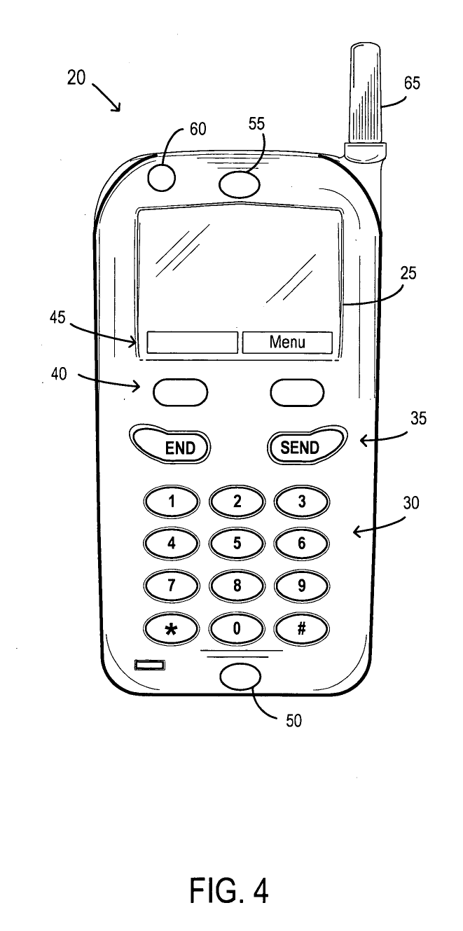

FIG. 4 is an outward view for explaining some elements of mobile telephone 20 according to some embodiments. Mobile telephone 20 may embody mobile telephone 2 of FIG. 1 and/or may execute processes 10 and/or 15 according to some embodiments. Mobile telephone 20 may include conventional components, and may include program code for performing certain functions described herein. Some embodiments may differ in part or in whole from mobile telephone 20.

Mobile telephone 20 may be compatible with one or more cellular communication protocols. Examples of such protocols include but are not limited to CDMA, Time Division Multiple Access (TDMA) (e.g., GSM, D-AMPS), and CDMAOne (e.g., PCS). Embodiments are not limited to devices offering cellular and/or telephone functionality.

Mobile telephone 20 includes display 25, keypad 30, fixed function keys 35, variable function keys 40, function key labels 45, microphone 50, speaker 55, power button 60 and antenna 65. Display 25 may present a user interface for receiving commands and data from a user. Alphanumeric keypad 30 is laid out like a conventional telephone dialing keypad, and fixed function keys 35 are used to initiate and terminate communication. Variable function keys 40 provide functions that vary in accordance with function labels 45 displayed on display 25 above keys 40.

Microphone 50 receives audio signals from a user. The signals may comprise speech to be transmitted to a call recipient. The audio signals may also or alternatively comprise commands for operating telephone 20.

Speaker 55 emits audio signals from telephone 20. The audio signals may comprise ring tones, beeps, alarms, and other tones used during operation of telephone 20, and/or speech or other audio signals received from another device such as another telephone. Speaker 55 may also emit audio signals representing speech or other sounds received by microphone 50.

Power button 60 may be used to turn mobile telephone 20 on and off. Antenna 65 may receive and transmit radio frequency signals from and to a cellular telephone network. Antenna 65 may be configured to transmit and receive any types of signals, including but not limited to infrared and Bluetooth signals.

In some examples of operation, a user operates keys 40 to access a function provided by telephone 20. Functions according to some embodiments may include an address book function, a contact information search function, a contact information transmit function, a game function, and a settings function. Mobile telephone 20 may provide any mobile telephone function that is or becomes known.

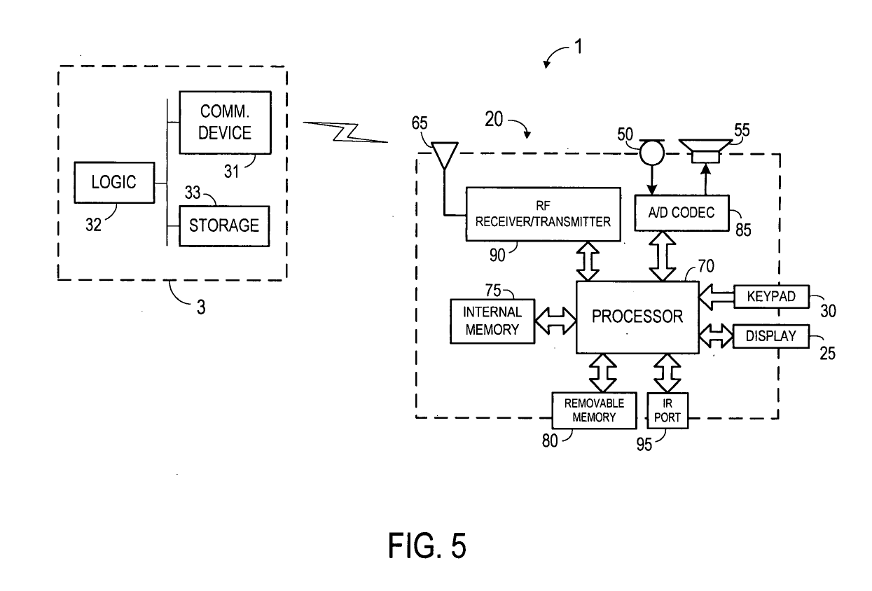

FIG. 5 is a diagram of system 1 including the internal architecture of mobile telephone 20 according to some embodiments. FIG. 5 also includes a block diagram of local external device 3 according to some embodiments.

The illustrated embodiment of mobile telephone 20 includes processor 70, which may be a conventional microprocessor, microcontroller and/or digital signal processor (DSP) or other control circuit conventionally provided in a mobile telephone. Processor 70 is shown in communication with keypad 30 and display 25 for control thereof.

Mobile telephone 20 also includes internal memory 75 and removable memory 80. Internal memory 75 may include one or more of ROM (read only memory), RAM (random access memory, e.g., static RAM), and flash memory. Removable memory 80 may comprise a flash memory, a Subscriber Identity Module (SIM) card or any other removable memory that is or becomes known. Mobile telephone 20 may therefore be equipped with an interface for physically receiving and transferring data to and from removable memory 80.

Memories 75 and 80 may store program code that is executable by processor 70 to control telephone 20. The program code may include but is not limited to operating system program code, application program code, device driver program code, and database connector program code. The program code may include code to cause telephone 20 to perform functions that are described herein.

Memories 75 and 80 may also store data used in the operation of mobile telephone 20. The data may be accessed by processor 70 during operation of mobile telephone 20. Such data may include contact information comprising phone numbers, post addresses, and email addresses. The data may also include access codes, audio files, and any other suitable data. Some or all of the data may be read-only, while other of the data may be rewritable.

Analog/digital coder/decoder (A/D codec) 85 is also in communication with processor 70. A/D codec 85 may receive analog signals from microphone 50, convert the analog signals to digital signals, and pass the digital signals to processor 70. Conversely, processor 70 may transmit digital signals to A/D codec 85, which converts the digital signals to analog signals and passes the analog signals to speaker 55. Speaker 55 then emits sound based on the analog signals.

RF receiver/transmitter 90 is a communication device operatively coupled to antenna 65. RF receiver/transmitter 90 may, in accordance with conventional practices, comprise a combination of two or more different receive/transmit modules (not separately shown) that operate in accordance with mutually different radio communication protocols to provide various services for the mobile telephone 20. For example, receiver/transmitter 90 may operate in accordance with one radio communication protocol to provide conventional two-way service for mobile telephone 20, and may operate in accordance with another radio communication protocol to provide PoC service for mobile telephone 20.

According to some embodiments, receiver/transmitter 90 transmits a query to device 3 for contact information and receives the contact information therefrom. Receiver/transmitter 90 also or alternatively receives a query for contact information from device 3 and transmits the contact information thereto. Receiver/transmitter 90 may comprise any element or elements for transmitting data to and/or receiving data from a local external device. Examples include but are not limited to an infrared port and a USB port.

Local external device 3 of the illustrated embodiment includes communication device 31, logic 32 and storage 33. Local device 3 may include more or fewer elements than those illustrated.

Communication device 31 may comprise any device to receive queries from and transmit contact information to mobile telephone 20. According to some embodiments, communication device 31 comprises any device or devices to transmit queries to and receive contact information from mobile telephone 20. Examples of communication device 31 according to some embodiments include an infrared port, an RF antenna, and a serial port.

Communication device 31 is in communication with logic 32. Logic 32 may comprise any suitable combination of discrete logic, microprocessor, microcontroller and other hardware used to impart functionality to device 3. Logic 32 may operate based on executable code stored in storage 33. Such code may include code of a contact information server application, and of other applications suitable for local external device 3.

Storage 33 may comprise any one or more types of electronic storage. Examples include hard disks, RAM, ROM, and removable storage such as Flash or other removable disks. Storage 33 may store data such as contact information, operating system files and device drivers used to operate unshown elements of local external device 3.

Those in the art will understand that the block diagram of FIG. 5 is simplified in a number of ways. For example, all power and power management components of mobile telephone 20 and device 3 are omitted from the diagram. Also, some embodiments may employ internal architectures somewhat or completely different from those shown in FIG. 5.

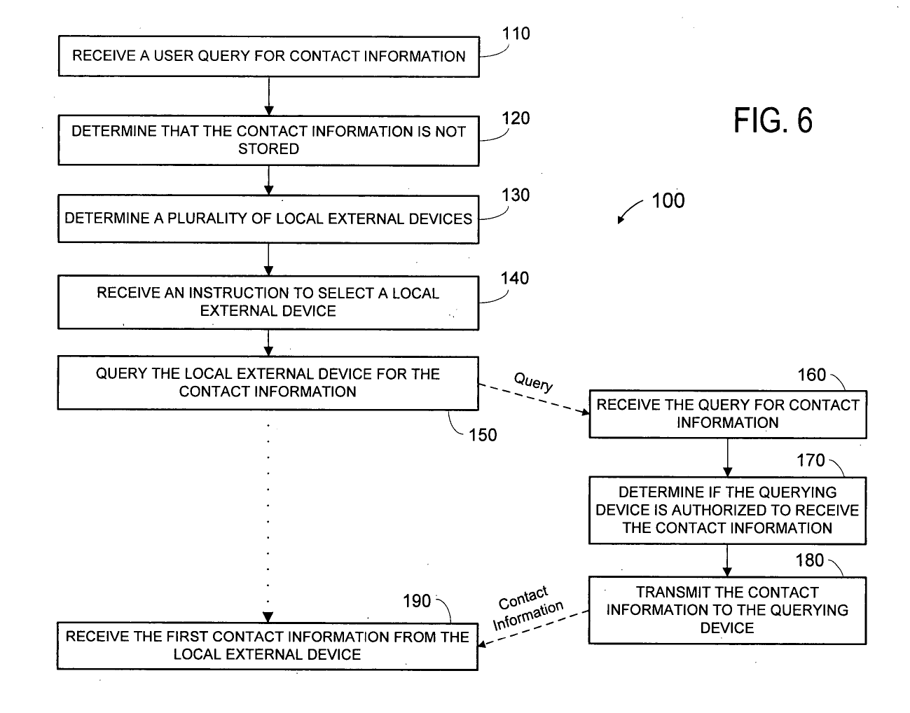

FIG. 6 is a flow diagram of process 100 according to some embodiments. Process 100 may be embodied in hardware and/or software of mobile telephone 20, local external device 3, and/or one or more other suitable devices. In the foregoing description, steps 110 through 150 and 190 of process 100 will be described as if embodied in program code of a “plug-in” application stored in internal memory 75 and executed by processor 70.

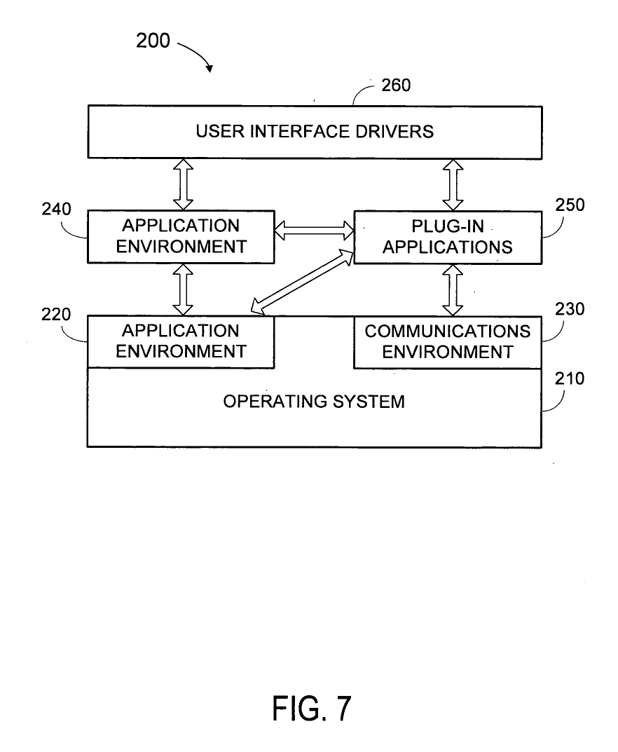

In this regard, FIG. 7 is a block diagram of a general software architecture that may support applications within mobile telephone 20 in conjunction with some embodiments. Architecture 200 includes operating system 210, which may comprise the Symbian® mobile telephone operating system. Any suitable operating system may be used in conjunction with some embodiments, including those not intended and/or usable with mobile telephones. Suitable operating systems according to some embodiments include but are not limited to Palm OS™, Windows CE™, and operating systems suitable for portable devices capable of transmissions to an external device (e.g., PDAs, digital media players, etc.).

Application environment 220 provides a platform by which another application environment 240 may interface with operating system 210. In this regard, application environment 240 may comprise a Java™ or C programming environment. As such, plug-in applications 250 may be written in Java or C for execution by mobile telephone 20. Plug-in applications 250 may also be written for the application interface provided by application environment 220.

Communications environment 230 provides plug-in applications 250 with access to the communications functionality of operating system 210. This functionality may include local wireless communication (e.g., infrared, Bluetooth, etc.), text messaging, email client functions, Web browsing and telephone communication. Plug-in applications 250 may also transmit data and commands to and receive input from user interface drivers 260 for control of the user interfaces of mobile telephone 20.

Although plug-in applications are specifically mentioned above, some embodiments comprise a standalone contact information client and/or server application that interfaces with application environment 240 and/or application environment 220.

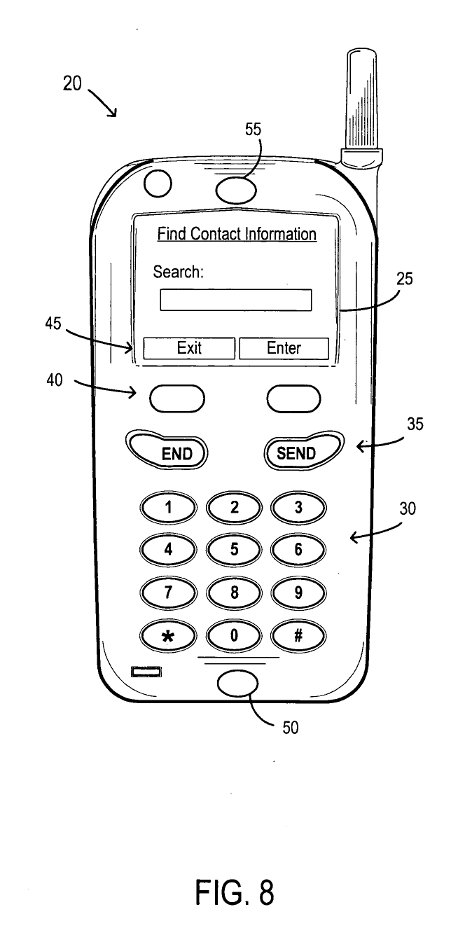

Returning to process 100, mobile telephone 20 receives a user query for contact information at step 110. Prior to step 110, a user may manipulate keypad 30 and variable function keys 40 to enter commands to launch an application for accessing contact information. Display 25 may present an interface of the application as a result. FIG. 8 is an outward view of mobile telephone 20 prior to step 110 according to the foregoing example. As shown, display 25 presents a main interface of a Find Contact Information application.

In some embodiments, a user uses keypad 30 to input characters into the input field presented on display 25. The user may enter any combination of characters usable to identify stored contact information. The characters may comprise all or a portion of a last name, first name, telephone number, street address, email address, and/or any other information that may be considered contact information. In the illustrated embodiment, the user then selects variable function key 40 associated with the “Enter” function label 45.

The user query is received by mobile telephone 20 at step 110 in response to selection of key 40 as described above. Other systems for receiving a user query for contact information may be employed in conjunction with some embodiments. Next, at step 120, mobile telephone 20 determines that contact information associated with the user query is not stored.

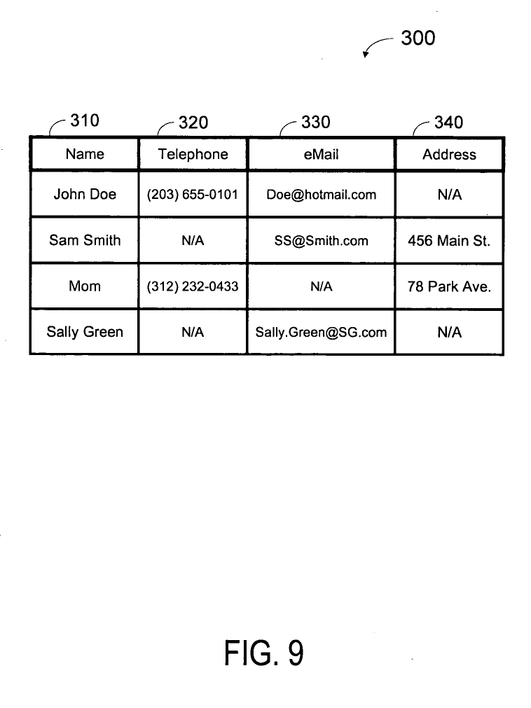

In some embodiments of step 120, mobile telephone 20 searches data stored in internal memory 75 for contact information that satisfies the received user query and determines that no such contact information is stored therein. FIG. 9 shows a tabular representation of a portion of contact information data structure 300 stored in internal memory 75 according to some embodiments. Fields of data structure 300 include Name field 310, Telephone field 320, eMail field 330, and Address field 340. Data structure 300 may include more or less fields than those shown, and additional fields may specify additional contact information or any other information.

According to some embodiments, mobile telephone 20 identifies contact information stored in internal memory 75 that somehow corresponds to the received user query and presents the identified information to the user. However, the user then indicates that the presented contact information is not the contact information in which the user was interested.

Next, at step 130, a plurality of local external devices are determined. The plurality of local external devices may be determined according to any device discovery protocol that is or becomes known. The Universal Plug and Play (UPnP) protocol may be employed to discover two or more local external devices according to some embodiments of step 130. According to these embodiments, both mobile telephone 20 and the discovered devices support the UPnP protocol.

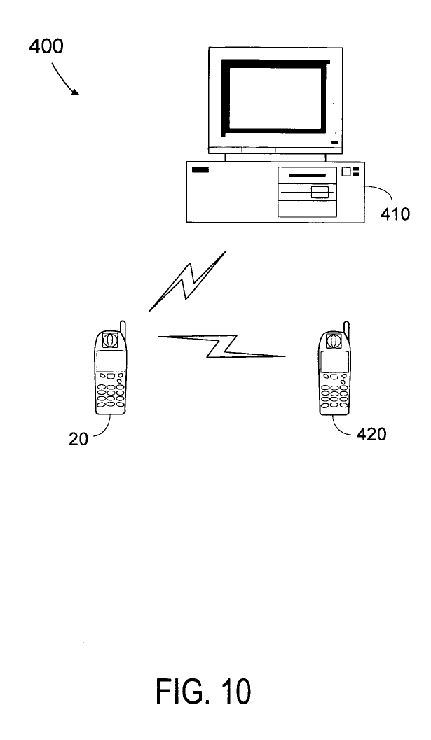

FIG. 10 illustrates system 400 according to some embodiments. As shown, mobile telephone 20 is in communication with local desktop computer 410 and local mobile telephone 420. It will be assumed that devices 410 and 420 are discoverable at step 130 (e.g., via the UPnP device discovery protocol) by mobile telephone 20. Moreover, mobile telephone 20 also determines at step 130 that devices 410 and 420 are capable of serving contact information (e.g., via the UPnP service discovery protocol).

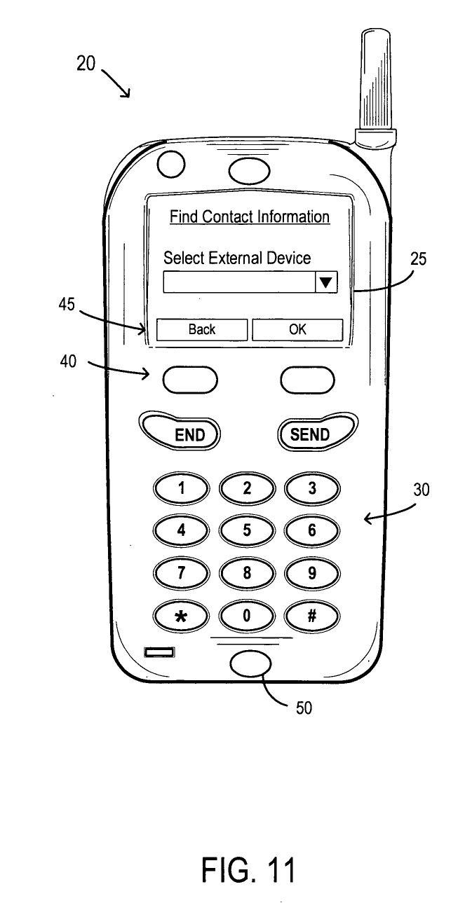

Mobile telephone 20 may then present the user with a list of the determined external devices. FIG. 11 is an outward view of mobile telephone 20 displaying an interface for receiving a user selection of one of the external devices. Display 25 of FIG. 11 includes a pull-down box that a user may manipulate to input an instruction to select one of the two determined devices. For example, the user may manipulate the pull-down box such that an identifier of one of the determined devices is displayed therein, and may then select key 40 associated with “OK” label 45 to input an instruction to select the identified device.

Mobile telephone 20 receives the instruction at step 140. In response to the instruction, mobile telephone 20 queries the selected local external device for the contact information at step 150. The query may be transmitted by RF receiver/transmitter 90 and received by communication device 31 of the selected device. The query may be in any format that is supported by the selected device. Continuing with the above example, the query may comprise an eXtensible Markup Language (XML) page supported by a UPnP-enabled application executed by the selected device.

The selected device receives the query at step 160. In this regard, the selected device may execute one or more software applications that support the protocols and provide the contact information-serving functionality mentioned herein. The selected local external device therefore analyzes its internal storage to determine whether it includes contact information satisfying the received query.

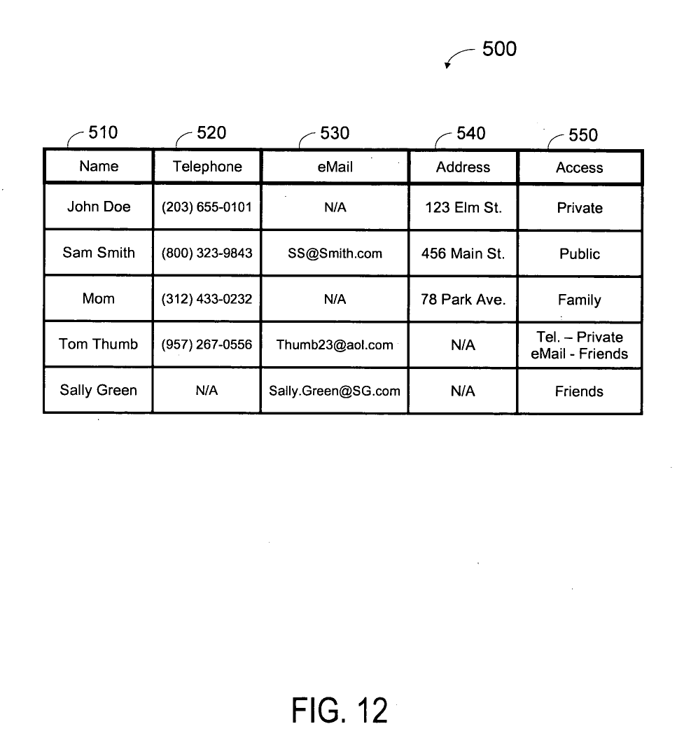

FIG. 12 is a tabular representation of a portion of contact information data structure 500 stored in storage 33 of the selected device according to some embodiments. Data structure 500 includes fields 510 through 540 corresponding to fields 310 through 340 of data structure 300, as well as Access field 550.

Access field 550 is used to determine whether data of an associated record is to be transmitted to a requester, such as mobile telephone 20 of the present example. Access field 550 may specify one or more groups of individuals or devices and/or specific individuals or devices. Assuming that the selected device stores the requested contact information, the device determines, at step 170, whether the querying device is authorized to receive the contact information based on Access field 550.

The determination at step 170 may be based on an identifier transmitted with the query at step 150. The identifier may indicate whether the user of mobile telephone 20 is a member of an approved access group (e.g., Family, Friends, etc.). In some embodiments, the selected device transmits a query back to mobile telephone 20 at step 170 asking for an access code or other identifying information that may be used to determine if mobile telephone 20 is authorized to receive the requested information.

The selected local external device transmits the requested contact information back to mobile telephone 20 at step 180 if it is determined that mobile telephone 20 is authorized to receive the information. The transmission may be performed by communication device 31 via any mutually-supported protocol. In some embodiments, the queried device might transmit an “Information Not Available” message at step 180 if the requested contact information is not stored therein and/or if mobile telephone is not authorized to receive the contact information.

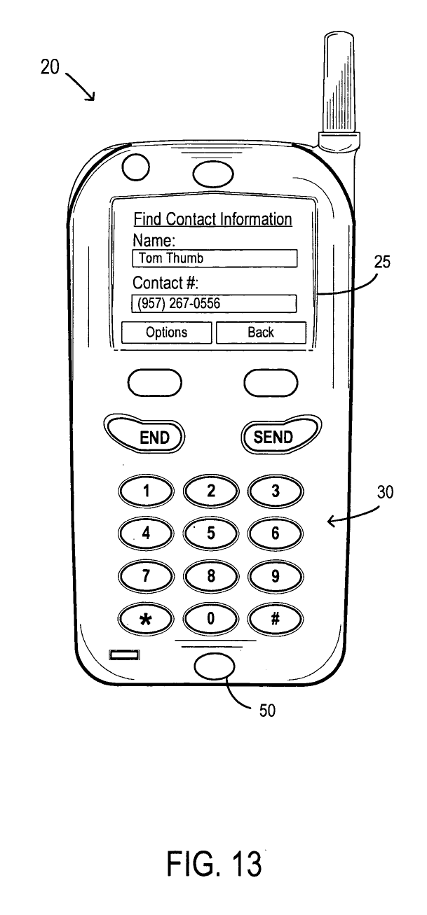

Mobile telephone 20 receives the contact information at step 190. FIG. 13 is an outward view of mobile telephone 20 displaying the received contact information. The received contact information may be displayed partially or in full according to some embodiments. The received contact information may be stored in internal memory 75 for later access by a user of telephone 20. Mobile telephone 20 may also or alternatively use the received contact information to place a telephone call or otherwise contact the individual associated with the contact information.

Some embodiments may differ in whole or in part from process 100. For example, mobile telephone 20 might determine only one local external device at step 130, in which case flow may proceed directly to step 150. According to some embodiments, mobile telephone 20 may automatically select one of the plurality of determined devices for querying according to some criteria such as a last update time, a trust rating, a proximity, a user-defined list of preferred source devices, etc.

Some embodiments may allow mobile telephone 20 to query one or more local external devices for a list of stored contact information. Such a list may be presented to the user, who may in turn select contact information from the list. Mobile telephone 20 then executes step 150 to query a device for the selected information and flow continues as described above.

According to some embodiments such as those described with respect to process 15, mobile telephone 20 may execute steps 160 through 180 of process 100. Steps 110 through 150 and 190 may therefore be performed by a local external device such as another mobile telephone, a personal computer, etc.

Embodiments described above are not intended to be limited to the specific form set forth herein, but are intended to cover such alternatives, modifications and equivalents as can reasonably be included within the spirit and scope of the appended claims.

What is claimed is:

1. A method for a mobile telephone, comprising:
querying a first local external device for first contact information; and
receiving the first contact information from the first local external device.

2. A method according to claim 1, further comprising:
determining a plurality of local external devices that store respective ones of a plurality of contact information; and
receiving an instruction to select the first local external device from the plurality of local external devices.

3. A method according to claim 2, wherein the plurality of local external devices comprise a second mobile telephone.

4. A method according to claim 1, further comprising:
querying the first local external device for a list representing all accessible contact information stored in the first local external device;
receiving the list representing all accessible contact information from the first local external device;
presenting the list to a user; and
receiving an instruction to select the first contact information from the list.

5. A method according to claim 1, further comprising:
receiving a user query for the first contact information; and
determining that the mobile telephone does not store the first contact information.

6. A method according to claim 1, wherein querying the first local external device for first contact information comprises querying a plurality of local external devices for the first contact information.

7. A mobile telephone, comprising:
a communication device to transmit a query to a first local external device for first contact information, and to receive the first contact information from the first local external device.

8. A mobile telephone according to claim 7, further comprising:
a processor to determine a plurality of local external devices that store respective ones of a plurality of contact information, the apparatus further comprising:
an input device to receive an instruction to select the first local external device from the plurality of local external devices.

9. A mobile telephone according to claim 8, wherein the plurality of local external devices comprise a second mobile telephone.

10. A mobile telephone according to claim 7, wherein the communication device is to transmit a query to the first local external device for a list representing all accessible contact information stored in the first local external device, and is to receive the list representing all accessible contact information from the first local external device, the apparatus further comprising:
an output device to present the list to a user, and
wherein the input device is to receive an instruction to select the first contact information from the list.

11. A mobile telephone according to claim 7, further comprising:
an input device to receive a user query for the first contact information,
wherein the processor is to determine that the mobile telephone does not store the first contact information.

12. A mobile telephone according to claim 7, wherein the communication device is to query a plurality of local external devices for the first contact information.

13. A method for a mobile telephone, comprising:
receiving a query from a first local external device for first contact information stored in the mobile telephone; and
transmitting the first contact information to the first local external device.

14. A method according to claim 13, further comprising:
determining if the first local external device is authorized to receive the first contact information.

15. A method according to claim 13, wherein the first local external device comprise a second mobile telephone.

16. A method according to claim 13, further comprising:
receiving a query from the first local external device for a list representing all accessible contact information stored in the mobile telephone; and
transmitting the list representing all accessible contact information to the first local external device.

17. A mobile telephone, comprising:
a communication device to receive a query from a first local external device for first contact information stored in the mobile telephone, and to transmit the first contact information to the first local external device.

18. A mobile telephone according to claim 17, further comprising:
a processor to determine if the first local external device is authorized to receive the first contact information.

19. A mobile telephone according to claim 17, wherein the first local external device comprise a second mobile telephone.

20. A mobile telephone according to claim 17, wherein the communication device is to receive a query from the first local external device for a list representing all accessible contact information stored in the mobile telephone, and to transmit the list representing all accessible contact information to the first local external device.
